(19) United States
(12) Patent Application Publication
(10) Pub. No.: US 2007/0251420 A1
(43) Pub. Date: Nov. 1, 2007

(54) Low emissive powder coating

(76) Inventors: Helene Bolm, Vaestervik (SE); Volker Rekowski, Sprockhoevel (DE); Jostein Mardalen, Trondheim (NO); Merete Hallenstvet, Tonsberg (NO); Thomas Jeffers, Houston, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/590,553

(22) Filed: Jan. 22, 2007

Related U.S. Application Data
(60) Provisional application No. 60/733,133, filed on Nov. 3, 2005.

(51) Int. Cl. B05D 1/00

(52) U.S. Cl. 106/287.17; 427/190

(57) ABSTRACT

A powder coating composition comprising an intimate mixture of at least one thermoplastic and/or thermosetting resin binder and optionally, at least one crosslinking agent and constituents conventional in powder coating compositions, such as, pigments, fillers and additives, comprising aluminum particles having a D50 in a range of 8 to 20 μm whereby the aluminum particles are treated with compounds selected from the group consisting of silica, (meth)acrylic polymers, polyesters and wax; the powder coating composition provides coatings with a value of thermal emissivity in a range of 0.4 to 0.55 with total solar reflectance values in a range of 60 to 70% in the infrared (IR) and/or near IR (NIR) wavelength region of 0.3 to 2.5 μm, to minimize the heat transportation through a substrate coated by the powder coating composition, e.g., from a warm building to a colder environment.

### CROSS-REFERENCE TO RELATED APPLICATION

This application claims the benefit of U.S. Provisional Application 60/733,133, filed Nov. 3, 2005, which is hereby incorporated by reference in its entirety.

### FIELD OF THE INVENTION

The invention is directed to a powder coating composition for coating substrate surfaces providing a low thermal emissive coating, and a method for producing such powder coating compositions.

### DESCRIPTION OF RELATED ART

Low thermal emissive coatings are known to minimize the heat transportation through a coated substrate to reduce the thermal radiation from an internal and interior object surface out to a colder environment. Similar coatings can also be used as heat reflective coatings which means the ability of the exterior coating to reduce the heat transportation from a warm environment into a colder object, e.g., a colder building.

Commonly metallic pigments, e.g., aluminum a pigments, such as, metal aluminum powder, inorganic and organic coated or encapsulated aluminum pigments, are used to produce such coatings providing thermal emissivity.

Thermal emissivity (emissivity) is the ability of a surface to emit electromagnetic radiation of wavelengths in the range of about 1 to 50 μm, weighed according to the radiation spectra of a black body at room temperature. The aluminum bare metal, e.g., has an emissivity value of 0.1, whereby clear coated aluminum may reach an emissivity in a range of about 0.3 to 0.9. Standard coatings of substrates typically resulting in emissivities in a range of 0.8 to 0.9 and higher.

EP-A 361 327 and CA-A 2 190 997 disclose paints providing a high reflectivity and a low emissivity of the coatings by using metal particles having a high electrical conductivity, e.g., aluminum flakes, respective using colloidal metal particles, such as, colloidal copper. In U.S. Pat. No. 6,017,981, metals and/or metal alloys are proposed to reduce the emissivity of wave lengths of the thermal infra red (IR) radiation. These coatings are provided by liquid coating compositions (solvent-borne, water-borne, aqueous dispersions or emulsions).

The use of aluminum pigments, leafing and/or non-leafing, in powder coating compositions is known especially to provide a silver effect of the coating. Leafing aluminum pigments orientate parallely to the surface of the coating film and may result in coatings with high hiding power but have a loss of durability. Non-leafing aluminum pigments are intimately bonded with the paint matrix and may give a better weatherability and durability of the coatings.

Normally powder coatings with, e.g., a good durability have high emissivity values in a range of higher than about 0.75.

There is a need to provide coatings based on powder coatings with a low emissivity combined with excellent coating properties, such as, durability, scratch resistance and a good appearance as well as an improved processing of specific pigments into the coating composition. Particularly the low emissive powder coatings should provide a good humidity and acid resistance and a high appearance to fulfill the requirements of architectural coating applications.

### SUMMARY OF THE INVENTION

The present invention provides a powder coating composition comprising an intimate mixture of at least one thermoplastic and/or thermosetting resin binder and optionally, at least one crosslinking agent (curing agent) as well as constituents conventional in powder coating compositions, such as, pigments, fillers and additives, comprising aluminum particles having a D50 in a range of 8 to 20 μm whereby the aluminum particles are treated with silica, (meth)acrylic polymers, polyesters and/or wax.

The value of D50 means: at least 50% of the aluminum particles have a particle size between 8 to 20 μm.

The powder coating composition according to the invention provides coatings with a value of the emissivity in a range of 0.4 to 0.55 with total solar reflectance values in a range of 60 to 70% in the infrared (IR) and/or near IR (NIR) wavelength region of 0.3 to 2.5 μm.

This makes it possible to minimize the heat transportation through a substrate coated by the powder coating composition, e.g., from a warm building to a colder environment. The powder coating composition of this invention gives excellent coating properties, particularly, good humidity and acid resistance and a good appearance, and it fulfills the requirements of architectural coating applications. The powder coating composition of this invention shows a good adhesion to, e.g., a primered substrate surface or to coating layers of a multi-layer coating system when using as top coat. Thin powder coating layers are possible using the powder coating composition according to the invention. An improved processing of the aluminum particles into the powder coating composition can be achieved resulting in optimum application properties of the powder coating composition.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The powder coating composition according to the invention comprising an intimate mixture of at least one thermoplastic and/or thermosetting resin binder and optionally, at least one crosslinking agent (curing agent) as well as constituents conventional in powder coating compositions, such as, pigments, fillers and additives, comprising aluminum particles having a D50 in a range of 8 to 20 μm whereby the aluminum particles are treated with silica, (meth) acrylic polymers, polyesters and/or wax.

The aluminum particles according to the invention have a particle size distribution of D50 in the range of 8 to 20 μm, preferably in the range of 10 to 15 μm (that means that at least 50% of the aluminum particles have a particle size between 10 to 15 μm). The maximal particles size of the aluminum particles is in the range of 25 to 45 μm.

The average particles size of the aluminum particles is in the range of 10 to 11 μm.

The aluminum particles can be treated with inorganic coatings, such as, silica.

Also, aluminum particles may be used which are treated with organic polymers selected from the group consisting of (meth) acrylic polymers, polyesters and a wax. Wax is preferably used. Examples of suitable waxes are polyamide wax, polyethylene wax, polypropylene wax and zinc stearate. The waxes can have modifications such as, being micronized or PTFE (Polytetrafluoroethylene) modified. Preferred are waxes, such as, polyamide wax and polyethylene wax.

Leafing and non-leafing aluminum particles are usable according to the invention. The leafing and non-leafing aluminum particles can be created by using specific additives during the production process of the aluminium pigments as known by a person skilled in the art.

The use of non-leafing aluminum particles is preferred.

Powder coating compositions which may be used are those based on thermoplastic and/or thermosetting resin binders known by a person skilled in the art, such as, polyvinyl thermoplastic resins, polyester resins, epoxy resins, (meth)acrylic resins, silicone resins, urethane resins and/or modified copolymers thereof, and, optionally, crosslinking resins (curing agent).

The term (meth) acrylate is respectively intended to mean acrylic and/or methacrylic.

Suitable polyesters are saturated and unsaturated polyesters. They may be produced in a conventional manner by reacting polycarboxylic acids, and the anhydrides and/or esters thereof with polyalcohols, as is, for example, described in D. A. Bates, The Science of Powder Coatings, volumes 1 & 2, Gardiner House, London, 1990. Unsaturated polyesters can be crosslinked by free-radical polymerization and can be prepolymers, such as, polymers and oligomers, containing, per molecule, one or more, free-radically polymerizable olefinic double bonds.

Examples of suitable polycarboxylic acids, and the anhydrides and/or esters thereof include maleic acid, fumaric acid, malonic acid, adipic acid, 1.4-cyclohexane dicarboxylic acid, isophthalic acid, terephthalic acid, acrylic acid, and their anhydride form, or mixtures thereof. Examples of suitable alcohols are benzyl alcohol, butanediol, hexanediol, diethylene glycol, pentaerytritol, neopentyl glycol, propylene glycol, and mixtures thereof.

Mixtures of carboxyl and hydroxyl group containing polyesters may be used. The carboxy-functionalized polyesters according to the invention have an acid value of 10 to 200 mg of KOH/g of resin and the hydroxy-functionalized polyesters an OH value of 10 to 200 mg of KOH/g of resin.

Epoxy resins are also usable as binder resins. Examples of suitable epoxy resins are unsaturated epoxies, such as, e.g., reaction products prepared from epichlorohydrin with bisphenol, for example, bisphenol A; functionalized resins such as, acrylated epoxies.

Suitable (meth)acrylic resins are unsaturated resins, such as, e.g., copolymers prepared from alkyl(meth)acrylates with glycidyl(meth)acrylates and olefinic monomers; functionalized resins such as, polyester acrylics, epoxy acrylics, urethane acrylates.

Suitable urethane resins are, e.g., unsaturated polyester urethanes, (meth) acrylic urethanes.

Suitable polyvinyl thermoplastic resins are, for example, polyethylene and/or polypropylene resins.

Preferably unsaturated polyesters, urethane acrylics, epoxy acrylics and (meth)acrylate resins prepared from alkyl(meth)acrylates with glycidyl(meth)acrylates and olefinic monomers are used as binder resin.

The resin binder have a glass transition temperature Tg in a range of, e.g., 35 to 80° C., Tg determined by means of differential scanning calorimetry (DSC). The number average molecular weight Mn of the resins is in the range of, e.g., 2000 to 10.000, Mn determined from gel permeation chromatography (GPC) using polystyrene standard.

Crystalline and/or semicrystalline binder resins are also usable which have a Tm (melting temperature) in the range of e.g., 50 to 150° C., determined by means of DSC.

The binder resins can also be at least one self crosslinkable resin containing cross-linkable functional groups known by a person skilled in the art.

The cross-linking agents may include conventional curing agents suitable for the group of resin binders known by a person skilled in the art. Example are cycloaliphatic, aliphatic or aromatic polyisocyanates; cross-linking agents containing epoxy groups, such as, for example, triglycidyl isocyanurate (TGIC); polyglycidyl ethers based on diethylene glycol; glycidyl-functionalized (meth)acrylic copolymers; and cross-linking agents containing amino, amido, (meth)acrylate or hydroxyl groups, as well as vinyl ethers. Furthermore, conventionally cross-linking agents such as, dicyanodiamide hardeners, carboxylic acid hardeners or phenolic hardeners are usable.

The powder coating compositions according to the invention may contain as further components the constituents conventional in powder coating technology, such as, additives, pigments and/or fillers as known by a person skilled in the art.

Additives are, for example, degassing auxiliaries, flow-control agents, flatting agents, texturing agents, fillers (extenders), photoinitiators, catalysts and dyes. Compounds having anti-microbial activity may also be added to the powder coating compositions.

The crosslinking reaction may be additionally accelerated by the presence in the powder coating composition according to the invention of catalysts known from thermal crosslinking. Such catalysts are, for example, tin salts, phosphides, amines and amides. They may be used, for example, in quantities of 0.02 to 3 wt %, based on the total weight of the powder coating composition.

The powder coating compositions may contain photoinitiators in order to initiate the free-radical polymerization. Suitable photoinitiators include, for example, those which absorb in the wavelength range from 190 to 600 nm. Examples for photoinitiators for free-radically curing systems are benzoin and derivatives, acetophenone and derivatives, benzophenone and derivatives, thioxanthone and derivatives, anthraquinone, organo phosphorus compounds, such as, for example, acyl phosphine oxides. The photoinitiators are used, for example, in quantities of 0 to 7 wt %, based on the total weight of the powder coating composition.

The powder coating composition may contain transparent, color-imparting and/or special effect-imparting pigments and/or fillers (extenders). Suitable color-imparting pigments are any conventional coating pigments of an organic or inorganic nature. Examples of inorganic or organic color-imparting pigments are titanium dioxide, micronized titanium dioxide, carbon black, azopigments, and phthalocyanine pigments. Examples of special effect-imparting pigments are metal pigments, for example, made from aluminum, copper or other metals, interference pigments, such as, metal oxide coated metal pigments and coated mica. Examples of usable extenders are silicon dioxide, aluminum silicate, barium sulfate, and calcium carbonate.

Preferred is the use of transparent pigments/fillers. It is also preferred to use pigment/filler-free powder coats.

The constituents are used in conventional amounts known to the person skilled in the art, for example, 0.01 to 25 wt. %, based on the total weight of the powder coating composition.

The powder coating composition according to the invention may comprise
(A) 40 to 98 wt % of at least one resin binder,
(B) 0 to 60 wt % of at least one crosslinking agent,
(C) 0.01 to 20 wt % of aluminum particles treated with compounds selected from the group consisting of silica, (meth) acrylic polymers, polyesters and wax, and
(D) 0.01 to 30 wt % of at least one coating additive, pigment and/or filler,

the wt % based on the total weight of the powder coating composition.

Preferred is a powder coating composition according to the invention comprising
(A) 60 to 95 wt % of at least one resin binder, selected from the group consisting of unsaturated polyesters, urethane (meth) acrylics, epoxy (meth) acrylics and (meth) acrylate resins prepared from alkyl(meth)acrylates with glycidyl (meth)acrylates and olefinic monomers,
(B) 1 to 40 wt % of at least one crosslinking agent
(C) 0.01 to 10 wt % of aluminum particles treated with compounds selected from the group consisting of silica and wax, and
(D) 0.01 to 25 wt % of at least one coating additive, pigment and/or filler,

the wt % based on the total weight of the powder coating composition.

The powder coating composition may be prepared by conventional manufacturing techniques used in the powder coating industry, such as, extrusion and/or grinding processes, with or without the aluminum particles according to the invention.

For example, the ingredients used in the powder coating composition, can be blended together with the aluminum particles and heated to a temperature to melt the mixture and then the mixture is extruded. The extruded material is then cooled on chill roles, broken up and then ground to a fine powder, which can be classified to the desired grain size, for example, to an average particle size of 20 to 200 μm.

The powder coating composition may also be prepared by spraying from supercritical solutions, NAD “non-aqueous dispersion” processes or ultrasonic standing wave atomization process.

Alternatively, the ingredients may also be processed without the aluminum particles.

Then the aluminum particles according to the invention may be processed with the finished powder coating particles after extrusion and grinding by dry-blending the aluminum particles with the powder coating particles.

Furthermore, the aluminum particles according to the invention may be processed with the finished powder coating particles after extrusion and grinding by a “bonding” process. Particularly, the aluminum particles are bonded with the coating powder particles using an impact fusion. For this purpose, the aluminum particles may be mixed with the powder coating particles. During blending, the individual powder coating particles are treated to softening their surface so that the aluminum particles adhere to them and are homogeneously bonded with the surface of the powder coating particles. The softening of the powder particles' surface may be done by heat treating the particles to a temperature, e.g., the glass transition temperature Tg of the composition, in a range, of e.g., 50 to 60° C. After cooling the mixture the desired particle size of the resulted particles may be proceed by a sieving process.

Preferably the aluminum particles may be incorporated into the powder coating composition via the above bonding process.

Therefore the invention also relates to a process for preparation of a powder coating composition.

The powder coating composition of this invention may be applied by, e.g., electrostatic spraying, thermal or flame spraying, or fluidized bed coating methods, all of which are known to those skilled in the art.

The coating compositions may be applied to, e.g., metallic substrates, non-metallic substrates, such as, paper, wood, plastics, for example, also fiber re-inforced plastic parts, glass and ceramics, as a one-coating system or as coating layer in a multi-layer film build.

The powder coating composition according to the invention may also be used for high speed on, for example, metal, wood, paper and film, for example, for the coil coating process at coating speeds of, for example, about >50 m/min.

In certain applications, the substrate to be coated may be pre-heated before the application of the powder composition, and then either heated after the application of the powder or not. For example, gas is commonly used for various heating steps, but other methods, e.g., microwaves, IR or NIR are also known.

The powder coating compositions according to the invention can be applied directly on the substrate surface or on a layer of a primer which can be a liquid or a powder based primer. The powder coating compositions according to the invention can also be applied as a top coat on the outer layer of a multilayer coating system on a substrate surface. That outer layer can be a liquid or powder topcoat and may also comprise a powder or liquid clear coat layer applied onto a color-imparting and/or special effect-imparting base coat layer or a pigmented one-layer powder or liquid top coat applied onto a prior coating.

The invention therefore also relates to a process for coating substrates by application of a powder coating composition according to the invention as at least one coating layer and curing the applied powder coating layer(s).

The applied and melted powder coating layer can be cured by thermal energy. The coating layer may, for example, be exposed by convective, gas and/or radiant heating, e.g., infra red (IR) and/or near infra red (NIR) irradiation, as known in the art, to temperatures of, e.g., 80° C. to 220° C., preferably of 120° C. to 200° C. (object temperature in each case).

The powder coating composition can also be cured by high energy radiation known by a skilled person. UV (ultraviolet) radiation or electron beam radiation may be used as high-energy radiation. UV-radiation is preferred. Irradiation may proceed continuously or discontinuously.

Dual curing may also be used. Dual curing means a curing method of the powder coating composition according to the invention where the applied composition can be cured, e.g., both by UV irradiation and by thermal curing methods known by a skilled person.

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

The following Examples illustrate the invention. The amounts are in parts per weight.

### EXAMPLES

### Example 1

Manufacturing of Powder Coating Compositions and Application

Formulation 1:

A powder coating composition is prepared according to the following formulation:

| | Percent |
|---|---|
| Product name (Formulation 1) | wt % |
| Uralac P 865 (unsaturated polyester) | 92.3 |
| bensoin (degassing agent) | 1.0 |
| Resiflow ® PV 88 (flow control agent) | 1.3 |
| Primid ® XL-552 (curing agent) | 4.8 |
| PTFE wax (scratch resistance agent) | 0.6 |

The ingredients of Formulation 1 are mixed together and extruded in an extruder PR 46 (firm: Buss AG) at 120° C. The meltmixed formulation is cooled and the resulted material is grinded to a D50 value of 40 μm particle size distribution.

The aluminum pigments Powdal 2900 and Powdal 1700 (silica-coated, firm: Schlenk) are used as aluminum particles according to the invention, and they are bonded to the resulted particles of Formulation 1 by the following process in general: The amount of powder particles based on Formulation 1 is loaded into a turbo mixer (e.g., firm: PLAS MEC) and is heated to a temperature of 57° C. during the high-speed mixing. The aluminum pigments are added under this temperature and under the high-speed mixing. After a blending time of 3 to 4 minutes the mixture is cooled to a temperature of about 25 to 26° C., and the resulting particles are sieved on a 150 μm sieve to give the formulations 2 and 3.

The unbonded aluminum pigments are separated from the bonded particles.

The final powder composition is applied to a metal sheet using a corona gun (firm: ITW Gema) to a film thickness of 80 μm. Finally the coating is cured in a convection oven at 200° C. for 10 minutes.

Formulations 2 and 3 Containing Aluminium Pigments According to the Invention, Emissivity of the Coatings:

To the powder Formulation 1 the aluminum pigments Powdal 2900 having a D50 of 11 μm were added in an amount of 4 parts per weight to 100 parts per weight of Formulation 1 (giving Formulation 2), and to the powder Formulation 1 the aluminum pigments Powdal 1700 having a D 50 value of 18 μm were added in an amount of 4 parts per weight to 100 parts per weight of Formulation 1 (giving Formulation 3), using the bonding process as mentioned above as well as the described application method.

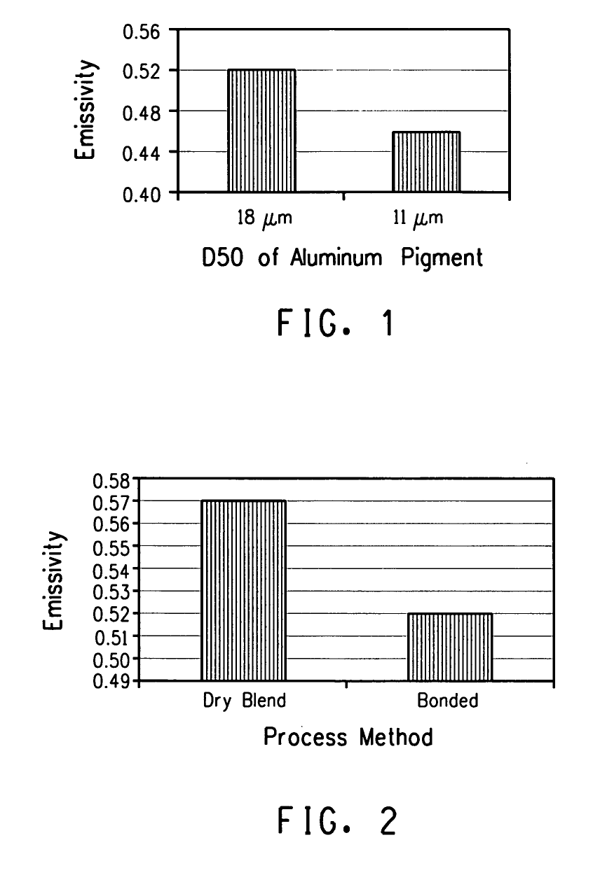

The emissivity of the coatings was measured, see FIG. 1.

The coatings based on formulations comprising aluminum pigments having these D50 values give low emissivity values.

Formulation 3 Containing Aluminium Pigments According to the Invention, Manufacturing Methods, Emissivity of the Coatings

To the powder Formulation 1 the aluminum pigment Powdal 1700 with a D 50 value of 18 μm was added in an amount of 4 parts per weight to 100 parts per weight of Formulation 1, using the dry-mixing process as known by a person skilled in the art and using the bonding process as mentioned above as well as the described application method.

The emissivity of the coatings was measured, see FIG. 2.

Both processes give coatings of low emissivity values.

### Example 2

Testing of the Coating Based on Formulation 2

TABLE 1
DSC - differential scanning calorimetry

| Property | Value |
|---|---|
| Gloss (ISO 2813) | 57.7% |
| Adhesion (EN ISO 2409) | 0 |
| Cupping test (EN ISO 1520) | 8.5 mm |
| Bend Test (EN ISO 1519), 5 mm mand | No cracks or delamination |
| Impact test (ASTM D 2794) | 2.5 Nm |
| Resistance for humid atmosphere | No infiltration > 1 mm on the |
| containing sulfur dioxide | scratch, no change in color, no |
| (EN ISO 3231) | |
| 24 cycles (ISO 4628-2) | blistering |
| Resistance to acetic salt spray (ISO | 1-2 mm / 6.6 mm2 infiltration |
| 9227) 1000 hc (ISO 4628-2) | over scratch No blistering |
| Accelerated Weathering test (Sun test) | 30% |
| (EN ISO 11341) | 2.23-1.21 |
| Loss of gloss | |
| Delta E (Included - Excluded) | |
| Resistance to boiling water (2 hours) | No defects and detachment, no |
| | blistering |
| Resistance to constant climate | No infiltration > 1 mm and no |
| condensation water test (DIN 50017) | blistering |
| 1000 h (ISO 4628-2) | |
| Thermal emissivity | 0.49 |
| Solar Reflectance (Lambda-19 | 61% |
| instrument of Perkin-Elmer), ISO 9050 | |
| Tg of uncured formulation 1 (DSC) | 54° C. |

A perfect black body will emit (send out) electromagnetic radiation according to Planck's law. The emitted intensity and spectral intensity distribution is determined by the black body temperature alone. No other variable parameter is influencing the spectrum. A body at room temperature (T=300K) will emit highest intensity at about 10 μm. This wavelength is in the thermal infrared range of the spectrum. A black body radiation spectrum at 300 K was used as a weighting function when calculating thermal emissivity.

The difference between irradiation from a real object and a perfect black body is given by the emissivity. The emissivity is related to the reflectivity.

The solar reflectivity (as a function of lambda) is measured and the emissivity (as a function of lambda) is calculated from that. The thermal emissivity is then found by integrating the lambda dependent emissivity weighted by the Planckian spectrum from a perfect T=300 K object.

The powder coating has a low thermal emissivity of 0.49 and a reflectance value of 61%. The high appearance is shown by the gloss value of 57.7%. The coating shows good results regarding the adhesion to the substrate and good resistance properties showing by the cupping test, bend test, impact test, weathering test, boiling water test, climate condensation water test. The humidity resistance is very good; the same to the acid salt spray resistance.

What is claimed is:

1. A powder coating composition comprising an intimate mixture of at least one thermoplastic and/or thermosetting resin binder and optionally, at least one crosslinking agent, and constituents conventional in powder coating compositions comprising pigments, fillers and additives and the composition comprising aluminum particles having a D50 in a range of 8 to 20 μm whereby the aluminum particles are treated with compounds selected from the group consisting of silica, (meth)acrylic polymers, polyesters and wax.

2. The powder coating composition according to claim 1 wherein the resulting coatings having a thermal emissivity in a range of 0.4 to 0.55 and a total solar reflectance in a range of 60 to 70% measured in the infrared (IR) and near IR (NIR) wavelength region of 0.3 to 2.5 μm.

3. The powder coating composition according to claim 1 wherein the resin binders are selected from the group consisting of unsaturated polyesters and (meth) acrylate resins.

4. The powder coating composition according to claim 1 comprising
(A) 40 to 98 wt % of at least one resin binder,
(B) 0 to 60 wt % of at least one crosslinking agent,
(C) 0.01 to 20 wt % of aluminum particles treated with compounds selected from the group consisting of silica and wax, and
(D) 0.01 to 30 wt % of at least one coating additive, pigment and/or filler,
the wt % based on the total weight of the powder coating composition.

5. The powder coating composition according to claim 1 comprising
(A) 60 to 95 wt % of at least one resin binder selected from the group consisting of unsaturated polyesters, urethane (meth)acrylics, epoxy (meth)acrylics and (meth)acrylate resins prepared from alkyl (meth) acrylates with glycidyl (meth)acrylates and olefinic monomers,
(B) 1 to 40 wt % of at least one crosslinking agent,
(C) 0.01 to 10 wt % of aluminum particles treated with compounds selected from the group consisting of silica, and wax, and
(D) 0.01 to 25 wt % of at least one coating additive, pigment and/or filler,
the wt % based on the total weight of the powder coating composition.

6 The powder coating composition according to claim 1 comprising transparent pigments and/or fillers.

7. A process for preparation of a powder coating composition using the powder coating composition of claim 4.

8. The process according to claim 7 using the bonding process comprising the steps
a) mixing the aluminum particles of component C) with the powder coating particles resulted from the extrusion of components A), B) and D),
b) heating the mixture to a temperature of 50 to 60° C. during mixing,
c) cooling the mixture and sieving to the desired particle size.

9. A process for coating substrate surfaces comprising applying the powder coating composition of claim 1 to the substrate surface.

10. The process according to claim 9 using the powder coating composition of claim 1 as top coat.

11. A coated substrate coated with the powder coating composition of claim 1 and cured.
